(19) United States
(12) Patent Application Publication
(10) Pub. No.: US 2016/0106104 A1
(43) Pub. Date: Apr. 21, 2016

(54) SILICONE-BASED ANTIMICROBIAL COMPOSITION

(71) Applicants: UNIVERSITE DU MAINE, Le Mans (FR); CENTRE NATIONAL DE LA RECHERCHE SCIENTIFIQUE (C.N.R.S.), Paris (FR); INSTITUTE OF BIOORGANIC CHEMISTRY AND PETROCHEMISTRY OF NATIONAL ACADEMY OF SCIENCES OF, Kiev, 94 (UA)

(72) Inventors: Jean-François Bardeau, Courceboeufs (FR); Sergell Rogalskyi, Kyiv (UA); Oksana Tarasiuk, Kyiv (UA); Liudmyla Loshyna, Kyiv (UA); Olga Bulko, Kyiv (UA)

(21) Appl. No.: 14/893,945

(22) PCT Filed: May 26, 2014
(86) PCT No.: PCT/EP2014/060857

§ 371 Date: Nov. 25, 2015

(30) Foreign Application Priority Data
May 28, 2013 (FR) 13 54800

(51) Int. Cl. A01N 47/44; A01N 43/50

(52) U.S. Cl. CPC A01N 47/44; A01N 43/50

(57) ABSTRACT

The present invention relates to a composition, comprising:
at least one non-crosslinked silicone, and
at least one antimicrobial agent dispersed within said silicone, said antimicrobial agent being selected from the group consisting of polymers of ionenes, and of ionic liquids with a molecular mass of less than 1,400 g/mol.

The present invention relates to polymeric compositions with antimicrobial properties, more particularly antimicrobial compositions based on silicone.

The surfaces of articles and coatings based on polymers which are exposed to humidity are rapidly colonized by noxious bacteria, fungi, yeasts, which may cause smells, deterioration of said articles and coatings, as well as infections, notably in the case of plastic articles inserted into the human body, like probes or catheters.

The use of antimicrobial agents, also called biocides, is then recommended for avoiding proliferation of microorganisms at the surface of such plastic articles and coatings.

Many families of biocides, either organic or inorganic, have already been used for giving antimicrobial properties to the surfaces of articles and coatings based on polymers. Materials based on crosslinked silicone, containing a silver derivative, have been prepared for limiting proliferation of micro-organisms present in beverage waters or waters (home toilets, swimming pool waters) which may be put into direct or indirect contact with human or animal individuals (FR 2 694 563). The drawback of these materials is that their antimicrobial properties are based on the slow release in aqueous media of silver derivatives.

Polymeric matrices containing quaternary ammonium salts have also been prepared for limiting development of colonies of bacteria (U.S. Pat. No. 6,572,926, WO 99/32157). However, the drawback of these materials is that a portion of the biocidal molecules is continuously released into the surrounding medium.

Moreover, impregnation with chlorhexidin/sulfadiazine silver or with the association minocyclin/rifampicin is used for reducing the risk of infection of catheters. Nevertheless, these uses promote the emergence of bacteria resistant to antiseptics and/or to antibiotics and are therefore not recommended.

Thus, one of the major drawbacks of the existing antimicrobial polymeric materials and coatings is the desalting of said biocides when said materials or coatings are in contact with aqueous media, either continuously or occasionally. Such desalting reduces the antimicrobial properties of the materials or coatings and causes a poisoning phenomenon of the medium in contact with the materials or coatings with the desalted biocide. By <<poisoning>>, is meant here to refer to the undesired release of active molecules, notably biocides, in an aqueous medium in direct or indirect contact with human or animal individuals, such as the human or animal body, or further beverage waters for example.

Another drawback of organic biocides is their lack of heat stability, which makes the production of antimicrobial materials and coatings difficult particularly when the latter is carried out at a high temperature.

An object of the present invention is to provide novel polymeric compositions with antimicrobial properties not having the drawbacks of those of the state of the art.

Another object of the present invention is to provide antimicrobial articles and coatings which are resistant to water, i.e. which do not release or very little an antimicrobial agent.

Another object of the present invention is to provide antimicrobial articles and coatings which are heat-stable.

As such, the object of the present invention is a composition based on silicone comprising an antimicrobial agent.

The object of the present invention is a composition, comprising:
at least one non-crosslinked silicone, and
at least one antimicrobial agent dispersed within said silicone, said antimicrobial agent being selected from the group consisting of polymers of ionenes, and of ionic liquids with a molecular mass of less than 1,400 g/mol.

The object of the present invention is also an antimicrobial article, comprising:
at least one crosslinked silicone, and
at least one antimicrobial agent dispersed within said crosslinked silicone, as mentioned above.

Silicones, or polysiloxanes, are inorganic compounds formed with a silicone- oxygen chain —[Si—O]ₙ—, where n is typically comprised from 100 to 10,000, wherein the silicone atoms are substituted with various substituents. As a substituent, for example mention may be made of C₁-C₆ alkyl groups, typically methyl groups, or halogen atoms, typically fluorine or chlorine atoms.

A non-crosslinked silicone is a silicone in which there is no branching between the silicone-oxygen chains —[Si—O]ₙ—. The non-crosslinked silicones are generally fluid at room temperature. These are also referred to as silicone oils.

Conversely, a crosslinked silicone is a silicone in which there exists branchings between the silicone-oxygen chains —[Si—O]ₙ—. Such branchings or crosslinkages, are typically obtained by adding a curing agent, or a crosslinking agent, to a non-crosslinked silicone composition as defined above. A crosslinked silicone according to the invention advantageously has a mechanical behaviour similar to rubber giving the possibility of forming supple and flexible articles, such as tubes or catheters for example.

Within the scope of the present invention, an <<antimicrobial agent>> is an organic compound having antimicrobial activity, which stops or inhibits proliferation of microorganisms, such as bacteria (Gram+ and Gram−), fungi, in particular fungi and yeasts, etc. The antimicrobial agents of the invention are generally capable of removing microorganisms and/or preventing their growth.

The antimicrobial agents of the invention preferably have a wide antimicrobial activity spectrum and low toxicity.

Preferably, the incorporation of antimicrobial agents of the invention gives the possibility of obtaining articles and coatings notably which resist to Candida albicans, T. Mentagrophytes, Escherichia coli, Bacillus coli, Aspergillus niger, Staphylococcus aureus etc.

According to certain embodiments, the incorporation of antimicrobial agents of the invention gives the possibility of obtaining articles and coatings resistant to:
bacteria such as Staphylococcus aureus, Staphylococcus epidermidis, Staphylococcus haemolyticus, Staphylococcus hominis, Escherichia coli, Klebsiella pneumoniae, Enterobacter cloacae, Enterobacter aerogenes, Enterococcus faecalis, Enterococcus faecium and/or Acinetobacter baumannii,
yeasts such as Candida albicans, Candida glabrata, Candida tropicalis, Candida parapsilosis and/or Candida krusei, and/or
fungi such as Aspergillus niger, Penicillium chrysogenum, Cladosporium sphaerospermum, Stachybotrys chartarum and/or Alternaria alternata.

Silicones are one of the most tested and widely used materials in the medical field from among all the bio-materials and are known for their intrinsic biocompatibility and biodurability. These characteristics are due to their chemical composition, to their intrinsic heat-stability, to their low surface tension and to their hydrophobicity. Because of these properties, silicones are used for producing catheters, drains and other medical products.

Non-crosslinked silicones according to the invention typically have an average molecular mass comprised from 1,000 to 50,000 g/mol, more particularly from 5,000 to 50,000 g/mol.

As a non-crosslinked silicone, mention may be made of poly(dimethylsiloxane) or PDMS.

The materials from the crosslinking of PDMS are medical materials which are highly inert which moreover have excellent chemical resistance. In vitro, these materials are not very prone to bacterial adhesion.

The mass proportion of non-crosslinked silicone in the composition of the invention is typically greater than 60%, preferably than 70%, advantageously than 80%, for example comprised from 90% to 99% based on the total mass of the composition.

The mass proportion of antimicrobial silver in the composition of the invention is typically from 1% to 10%, preferably from 1% to 9%, advantageously from 2% to 8%, preferentially from 3% to 7%, more preferentially from 4% to 6%, for example equal to 2% or 5% based on the total mass of the composition.

Advantageously, the mass proportion of antimicrobial agent (and of optional additives) in the composition of the invention is such that it does not cause any modification of the intrinsic properties of the silicone (non-crosslinked or crosslinked) in which it is dispersed.

Within the scope of the present invention, by “dispersed” is meant that the antimicrobial agent is homogenously mixed with the silicone within the composition of the invention.

Thus, the composition of the invention is preferably a homogenous mixture comprising at least one non-crosslinked silicone and at least one antimicrobial agent as defined in the present description. According to a particular embodiment, the composition of the invention consists of a non-crosslinked silicone and of an antimicrobial agent as defined hereafter.

The antimicrobial agent present in the composition of the invention may belong to different classes of compounds.

According to an embodiment, the antimicrobial agent is a polymer of ionenes.

Within the scope of the present invention, by <<polymer of ionenes>> is meant a polymer consisting of recurrent units (monomers) as a salt. Most often, the recurrent units comprise at least one nitrogen atom in ammonium form <<N+>> and at least one organic or inorganic counter-anion A.

The antimicrobial agent may notably be a salt of poly(polymethylene) guanidine, comprising n recurrent units of formula (I-1):

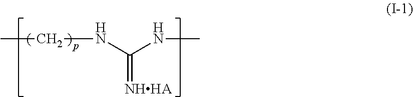

wherein:
p is comprised from 2 to 12,
n is comprised from 4 to 140,
HA is selected from the group consisting of (CF₃SO₂)₂NH, HPF₆ and R—SO₃H,
R is selected from the group consisting of C₄-C₁₂ perfluoroalkyl groups and C₄-C₁₀ aryl groups substituted with at least one group R′, and
R′ is selected from the group consisting of H; C₁-C₁₈ alkyl groups; —NH—CO— R″ groups wherein R″ is a C₁-C₁₇ alkyl group or a C₄-C₁₀ aryl group; and groups —NH—SO₂—C₆H₄—R′″ wherein R′″ is a hydrogen atom or a C₁-C₆ alkyl group.

Preferably, in formula (I-1), p is equal to 6.

Preferably, in the formula (I-1), HA is R—SO₃H wherein R is a phenyl or naphthyl group substituted with a C₁-C₂₄ alkyl group.

According to the present invention, the notation “.” in “═NH.HA”, used for representing a salt, means a salt of formula “═NH₂⁺.A⁻”.

According to the present invention, the <<alkyl>> groups represent saturated hydrocarbon groups with a linear or branched chain, comprising from 1 to 24 carbon atoms. Mention may notably be made when they are linear, of the methyl, ethyl, propyl, butyl, pentyl, hexyl, octyl, nonyl, decyl and dodecyl groups. Mention may notably be made, when they are branched or substituted with one or several alkyl groups, of the isopropyl, tert-butyl, 2-ethylhexyl, 2-methylbutyl, 2-methylpentyl, 1-methylpentyl and 3-methylheptyl groups.

According to the present invention, the <<perfluoroalkyl>> groups represent alkyl groups, generally linear, wherein all the hydrogen atoms have been replaced with fluorine atoms. The C₄-C₁₂ perfluoroalkyl groups have the formulas C₄F₉ to C₁₂F₂₅.

According to the present invention, the <<aryl>> groups represent a mono or bicyclic hydrocarbon aromatic system comprising from 4 to 10 carbon atoms. From among aryl groups, mention may notably be made of the phenyl or naphthyl group.

When the aryl group comprises at least one heteroatom selected from N, O and S, this is referred to as a <<heteroaryl>> group. As a monocyclic heteroaryl group, mention may be made inter alia of pyrrole, furane, thiophene, imidazole, pyrazole, oxazole, thiazole and pyridine. As a bicyclic heteroaryl group, mention may notably be made of indole.

Preferably, the antimicrobial agent is a salt of poly(hexamethylene) guanidine, comprising n recurrent units of formula (I-1′):

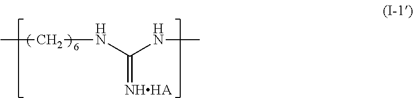

wherein n and HA are as defined above.

Preferably, in formula (I-1′), HA is R—SO₃H wherein R is a phenyl or naphthyl group substituted with C₁-C₂₄ alkyl group.

The salts of poly(polymethylene) guanidine (PpMG), more particularly the salts of poly(hexamethylene) guanidine (PHMG) are known as biocides having a wide activity spectrum (M. K. Oulé et al. Poly(hexamethylene)guanidine hydrochloride-based disinfectant: a novel tool to fight meticillin-resistant Staphylococcus aureus and nosocomial infections, Journal of Medical Microbiology, Vol. 57, 1523-1528 (2006)).

The salts of poly(polymethylene) guanidine (PpMG), more particularly the salts of poly(hexamethylene) guanidine (PHMG), are thermally stable under conditions for making antimicrobial compositions and antimicrobial articles according to the invention.

Said salts are also resistant to water. In particular, the antimicrobial articles according to the invention comprising a salt of PpMG, more particularly of PHMG, exhibit very little, or even no desalting of said salts when they are in contact with an aqueous medium, and this, even in a prolonged way, typically over one month, or even one year.

Said articles advantageously thus preserve their antimicrobial properties over long periods, while avoiding any poisoning phenomenon of the medium in which they are present by desalting of said salts.

Preferably, in the formulas (I-1) and (I-1′), HA represent a dodecylbenzenesulfonic acid of formula:

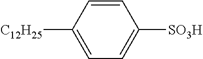

As an antimicrobial agent of the PpMG salt type, mention may be made of poly(hexamethylene) guanidine dodecylbenzenesulfonate (also called PHMG-DBS), which corresponds to a salt of formula (I-1) wherein n=6 and HA is dodecylbenzenesulfonic acid.

The antimicrobial agent may also be a salt of poly(polymethylene) imidazolium, comprising n′ recurrent units of formula (I-2):

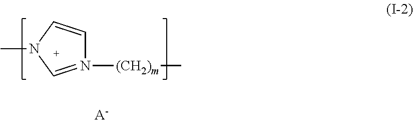

wherein:
m is comprised from 6 to 12,
n′ is comprised from 10 to 100, and
A⁻ is selected from the group consisting of BF₄⁻, PF₆⁻ and (CF₃SO₂)₂N⁻.

Preferably, in formula (I-2), m is equal to 6.

According to another embodiment, the antimicrobial agent is an ionic liquid with a molecular mass of less than 1,400 g/mol.

Within the scope of the present invention, by <<ionic liquid>> is meant a salt, consisting of an anion and of a cation, having a melting temperature of less than 100° C., and often even less than room temperature. Certain ionic liquids are in the liquid state at room temperature and are called room temperature ionic liquids. The latter have practical advantages over high melting temperature ionic liquids and are therefore more used.

In the ionic liquids of the invention, the cations are generally of the dialkylimidazolium, tetraalkylammonium, tetraalkylphosphonium or alkylpyridium type.

In the ionic liquids of the invention, the anions are generally of the tetrafluoroborate, hexafluorophosphate, halide, mesylate, tosylate, or triflate type.

Preferably, the cations of the ionic liquids of the invention are organic.

The molecular mass of the ionic liquids of the invention is preferably comprised from 200 to 1,350 g/mol, preferably comprised from 200 to 600 g/mol.

The antimicrobial agent may notably be an ionic liquid 1,3-dialkylimidazolium fitting the formula (II-1):

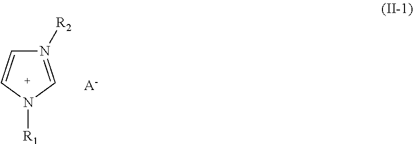

wherein:
A⁻ is selected from the group consisting of BF₄⁻, PF₆⁻ and (CF₃SO₂)₂N⁻,
R₁ is a C₁-C₁₆ alkyl group or a C₅-C₁₆ alkylaryl group, and
R₂ is selected from the group consisting of C₄-C₁₆ alkyl groups, C₅-C₁₆ alkylaryl groups and groups of formula (II-1′):

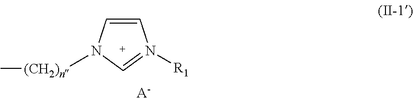

wherein n″ is comprised from 6 to 12, R₁ and A⁻ are as defined above.

According to the present invention, the term of “alkylaryl” refers to an -alkyl-aryl group, the terms of alkyl and aryl being as defined above.

The term <<alkylaryl>> notably refers to a benzyl group (—CH₂—C₆H₅).

Preferably, in formula (II-1), R₁ is a methyl group.

Preferably, in formula (II-1), R₂ is C₈^{-C}₁₂ alkyl group.

Preferably, in formula (II-1), A⁻ is BF₄⁻.

The 1,3-dialkylimidazolium ionic liquids of formula (II-1) have a wide activity spectrum, are heat-stable under the conditions for manufacturing antimicrobial compositions and antimicrobial articles according to the invention.

Said ionic liquids are also resistant to water. In particular, the antimicrobial articles according to the invention comprising such ionic liquids, exhibit very little, or even no salting of said ionic liquids when they are in contact with an aqueous medium, and this, even in prolonged way, typically over one month, or even one year.

Said articles thus advantageously keep their antimicrobial properties over long periods, while avoiding any poisoning phenomenon of the medium in which they are present by desalting of said ionic liquids.

Preferably, in formula (II-1):
R₁ is a methyl group,
R₂ is a C₈-C₁₂ alkyl group, and
A⁻ is BF₄⁻.

As an antimicrobial agent of the ionic liquid type from the family of 1,3-dialkylimidazoliums, mention may be made of 1-octyl-3-methylimidazolinium tetrafluoroborate (also called OMIM-BF₄) and 1-dodecyl-3-methylimidazolinium tetrafluoroborate (also called DMIM-BF₄).

These specific ionic liquids have an antimicrobial activity with a wide spectrum and low toxicity (see Y. Yu, Y. Nie, Environ. Protec., 2, 298-303 (2011) and B. F. Gilmore, M. J. Earl, Chimica oggi/Chemistry Today, 29 (2): 50-53 (2011)).

The antimicrobial agent may also be a guanidinium ionic liquid fitting the formula (II-2):

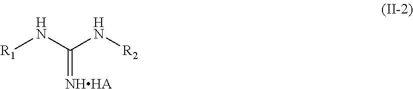

wherein:
R₁ represents a hydrogen atom or C₁₂-C₁₆ alkyl group,
R₂ represents a C₄-C₁₆ alkyl group,
HA is selected from the group consisting of (CF₃SO₂)₂NH, HPF₆ and R—SO₃H,
R is selected from the group consisting of C₄-C₁₂ perfluoroalkyl groups and C₄-C₁₀ aryl groups substituted with a group R′, and
R′ is selected from the group consisting of H; C₁-C₁₈ alkyl groups; groups —NH—CO—R″ wherein R″ is a C₁-C₁₇ alkyl group or a C₄-C₁₀ aryl group; and groups —NH—SO₂—C₆H₄—R′″ wherein R′″ is a hydrogen atom or a C₁-C₆ alkyl group.

The antimicrobial agent may also be a phosphonium ionic liquid fitting the formula (II-3):

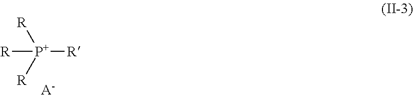

wherein:
R is a C₄-C₁₂ alkyl group,
R′ is selected from the group consisting of C₂-C₁₆ alkyl groups, C₅-C₁₆ alkylaryl groups, and groups of formula (II-3′):

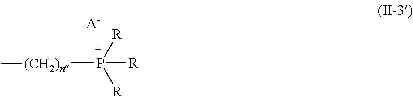

wherein n′″ is comprised from 6 to 12, R being as defined above, and
A⁻ is selected from the group consisting of BF₄⁻, (CF₃SO₂)₂N⁻, PF₆⁻, P(O)(OR₁)₂O⁻ and R₂—SO₃⁻,
R₁ is a C₄-C₈ alkyl group,
R₂ is selected from the group consisting of C₄-C₁₂ perfluoroalkyl groups, C₈-C₁₈ alkyl groups, and C₄-C₁₀ aryl groups substituted with a group R₃, and
R₃ is selected from the group consisting of H; C₁-C₁₆ alkyl groups; —NH—CO—R₄ groups wherein R₄ is a C₁-C₁₇ alkyl group or a C₄-C₁₀ aryl group; and groups —NH—SO₂—C₆H₄—R₅ wherein R₅ is a hydrogen atom or a C₁-C₆ alkyl group.

The object of the present invention is also the use of a composition according to the invention, for preparing an antimicrobial article.

The compositions according to the invention are useful for preparing articles and coatings of diverse sizes and shapes.

It is notably possible to prepare articles as a film intended to be deposited on rigid or flexible supports, of a flexible film, of a flexible tube or catheter.

The antimicrobial articles of the invention may be used in the medical field.

Infections of catheters are mainly caused by gram+ and gram− bacteria. Fungal infections are less frequent than bacterial infections, but they tend to be more serious and are an increasing problem. Today they represent about 10% of all the nosocomial infections. Urinary catheters, prosthetic cardiac valves and heart stimulators are also often associated with fungal infections. It was shown that biofilms containing both bacteria and yeasts were also associated with infections of endotracheal tubes, of biliary stents, of vocal silicone prostheses and acrylic dental prostheses.

The antimicrobial articles of the invention are notably used for controlling nosocomial infections related to the colonization of implantable chambers (intravenous devices for a long period used for delivering chemotherapies in the treatment of cancers) and of catheters.

Thus, the antimicrobial articles according to the invention give the possibility of reacting to these problems, while avoiding diffusion of antimicrobial agents in vivo (poisoning phenomenon).

The antimicrobial articles according to the invention may be used as a catheter, surgical draining, probe (tracheal, urinary, digestive, etc), or a prosthesis (nipples, etc).

They have the advantage of being well supported by the skin and the tissues at their contact.

The antimicrobial articles of the invention may also be used in the home and food domain.

The antimicrobial articles of the invention may be used for making tubes for transferring food liquids such as coffee, fruit juices, soups, or other food or non-food liquids.

Another application is the making of silicone tactile keys for computer keyboards, seal gaskets for sanitary or industrial applications, or tubes for circulating gas and air in airplanes.

Another application of the articles of the invention relates to the field of interior habitat (for example joints of bathrooms) and the automotive field.

Advantageously, the antimicrobial articles of the invention have a desalting rate of antimicrobial agent of less than 5% per year, preferably less than 1% per year, or even less than 0.1% per year.

By <<desalting rate>>, is meant the ratio of the antimicrobial agent mass desalted by the antimicrobial article during one year, over the antimicrobial agent mass initially present within the antimicrobial article.

The desalting rate may be measured by X fluorescence spectrometry.

X fluorescence spectrometry (XRF for X-ray fluorescence) is a chemical analysis method using a physical property of matter, the fluorescence of X-rays. When matter is bombarded with X rays, the matter re-emits energy inter alia in the form of X rays; this is X fluorescence, or secondary emission of X rays. The spectrum of the emitted X rays by the matter is characteristic of the composition of the sample. By analyzing this spectrum, it is possible to infer the elementary composition of the sample therefrom, i.e. the mass concentrations of elements, and thus observe the time-dependent change in the concentration of antimicrobial agent of the antimicrobial articles of the invention.

The antimicrobial articles of the invention advantageously have a substantially zero antimicrobial agent desalting rate.

By <<substantially zero>>, is meant that over a period of at least six months, or even one year, the amount of antimicrobial agent desalted by the antimicrobial articles of the invention is zero or hardly detectable by analysis means such as X fluorescence spectrometry (i.e. it is of the order of the accuracy of the measurement, i.e. 1 ppm for X fluorescence spectrometry).

The object of the present invention is also a method for preparing an antimicrobial article, comprising the steps of:
mixing a non-crosslinked silicone and an antimicrobial agent as defined above in order to obtain a liquid composition,
adding a curing agent to said liquid composition,
crosslinking of the silicone of the thereby obtained mixture, and
recovering the thereby formed antimicrobial article.

According to the present invention, the term of <<curing agent>> refers to a reactive chemical compound able to crosslink a silicone, i.e. generating branchings between the linear chains —[Si—O]ₙ— of the non-crosslinked silicone.

As a curing agent, may notably be mentioned any commercial silicone curing agent, such as compounds of the tetraalkoxytitanium or tetraethoxysilane type.

The mixture of a non-crosslinked silicone and of an antimicrobial agent is typically carried out with mechanical or magnetic stirring, optionally by using ultrasonic waves, and optionally by heating the mixture. Preferably, the stirring and/or heating conditions are adapted so as to obtain total solubilization of the antimicrobial agent in the non-crosslinked silicone.

In the case of an antimicrobial film, after adding the curing agent, the obtained mixture is typically homogenized and then cast on a surface on which will form said film by crosslinking.

In the case of an antimicrobial article with a predetermined shape, after adding the curing agent, the obtained mixture is typically homogenized and then cast into a mold, or else extruded via a nozzle, the shape of which corresponds to that of the article which is desirably obtained.

The crosslinking mode may be adapted according to the curing agent used and to the mechanical properties of the article which is desirably obtained. For example, crosslinking may be carried out by UV exposure, IR exposure, heat treatment or chemical treatment.

### EXAMPLES

### Example 1

### Antimicrobial Agents

The following antimicrobial agents were used:

Agent 1: poly(hexamethylene) guanidine dodecylbenzenesulfonate (PHMG-DBS)

Agent 2: 1-octyl-3-methylimidazolium tetrafluoroborate (OMIM-BF₄)

Agent 3: 1-dodecyl-3-methylimidazolium tetrafluoroborate (DMIM-BF₄)

PHMG-DBS was prepared according to the method described in WO 2011/131773.

### Example 2

### Preparation of Silicone Compositions

The compositions C1, C2 and C3 were prepared by respectively dissolving agent 1, agent 2 or agent 3, into liquid silicone (FORMASIL).

The mass proportion of agent 1, 2 or 3 is 2% or 5% based on the total weight of the composition C1, C2 or C3.

### Example 3

### Preparation of Antimicrobial Films

A curing agent (tetraethoxysilane) was then added (5% by weight) to each of the compositions C1, C2 and C3 and the obtained mixture was left at rest for 24 hours at room temperature, in order to obtain flexible and semi-transparent films F1, F2 and F3 (diameter of 5 cm).

In the same way, a control film F0 was also prepared, not comprising any antimicrobial agent.

### Example 4

### Microbiological Analyses

Microbiological analyses were carried with the Escherichia coli strain (GM 2163).

The bacteria were cultivated overnight in 5 ml of LB culture medium. The medium was then sterilized in an autoclave (20 min at 15 psi) (10.34 kPa)) at 37° C. up to a concentration of 10⁸ CFU per ml (optical density of 0.2 at 620 nm). And then, 40 μl of the thereby prepared suspension of bacteria were deposited on an LB agar culture medium. Thereby four culture media were inoculated in the same way.

Each film (F0, F1, F2 or F3) was then deposited on one of the 4 culture media inoculated beforehand. Said films were left in contact with the culture media for 6 h at 37° C., and then were withdrawn, and the culture media were kept for 18 h at 37° C.

The results were observed with the naked eye.

No difference was observed between the area of the culture medium which was in contact with the film F0 and the area which was not. The application of the control film F0 on the culture medium therefore had no effect, either positive or negative, on the development of the bacteria.

On the other hand, the areas of the culture media which were respectively in contact with the film F1, the film F2 and the film F3, appeared to be clearer which expresses the absence of bacteria at these locations. The areas which were not in contact with the film F1, F2 or F3, as for them, were always covered with bacteria.

The application of the film F1, F2 or F3 on the culture medium thus removed the bacteria and prevented their development on the contact area between the film and the agar surface. The antimicrobial activity of the films F1, F2 and F3 corresponding to the invention was thus demonstrated.

### Example 5

### In Vitro and In Vivo Analyses

Films with different compositions (6%, 4%, 2%, 1%, 0.5%, 0% by mass of antimicrobial agent) are tested on bacteria and fungi, such as yeasts and fungi.

Bacterial strains responsible for septicemias on catheters are tested, i.e.: Staphylococcus aureus, Staphylococcus epidermidis, Staphylococcus haemolyticus, Staphylococcus hominis, Escherichia coli, Klebsiella pneumoniae, Enterobacter cloacae, Enterobacter aerogenes, Enterococcus faecalis, Enterococcus faecium and Acinetobacter baumannii.

Yeasts responsible of septicemias on catheters are also tested, i.e.: Candida albicans, Candida glabrata, Candida tropicalis, Candida parapsilosis and Candida krusei.

In vitro tests at 25° C., in a chamber or oven with controlled hygrometry (relative humidity HR>95-98%), according to the ISO 846:1997 standard (Plastics—Evaluation of the action of micro-organisms), are conducted on a series of fungi, the sanitary impact of which is well known in habitats, i.e.: Aspergillus niger, Penicillium chrysogenum, Cladosporium sphaerospermum, Stachybotrys chartarum and Alternaria alternata.

In vivo tests are also conducted on rats in order to guarantee biocompatibility of the antimicrobial films. For this, modified silicone film samples are introduced into the arteries of rats, and after a few days, it is checked whether any sign of thrombosis, infection or platelet activation may be observed.

### Example 5A

### Tests on Bacteria According to the ISO 22196 Standard

The antibacterial activity of the silicone compositions of the invention was tested on 6 lines of bacteria, according to the procedure for the ISO 22196 standard (second edition, 2011).

The lines of tested bacteria are: Klebsiella pneumoniae DSM 16609, Staphylococcus aureus ATCC 25923, Enterococcus faecalis ATCC 29212, Escherichia coli ATCC 8739, Acinetobacter baumannii CIP 70.34 and Enterobacter cloacae DSM 30054.

Silicone films were prepared according to Examples 2 and 3, comprising 0%, 2% or 5% of antimicrobial agent PHMG-DBS, OMIM-BF₄ or DMIM-BF₄ (7 types of silicone films were therefore prepared).

Square pieces of silicone films with dimensions 25 mm×25 mm were cut out, as well as squares of polypropylene of dimension 20 mm×20 mm. The latter were passed in the autoclave at 115° C. for 20 minutes.

The bacteria were cultivated overnight at 37° C. in an agar culture medium. Suspensions of bacteria were then prepared in a nutrient broth culture medium with a bacterial concentration of 6.10⁵ CFU/ml.

Each silicone square (not sterilized) was placed on a lid of a Petri dish with a diameter of 55 mm, which itself was placed in a Petri dish with a diameter of 94 mm. 100 μl of bacterial suspension were deposited on each silicone square and spread out by means of a polypropylene square. 10 ml of sterile water were added in the bottom of the Petri dish with a diameter of 94 mm in order to ensure high relative humidity during incubation at 37° C. for 24 hours. For each silicone film type, three specimens were made.

After incubation, each silicone film was placed in a new Petri dish and washed with 10 ml of antibacterial agent (SCDLP, according to the standard procedure of the ISO standard) for recovering the bacteria. After 5 washes, the SCDLP suspension was diluted down to 10⁻⁶, and 1 ml of obtained solution was placed on a gelose plate PCA (duplicated). Each plate was incubated at 37° C. for 24 hours. The number of colonies on each Petri dish was then counted.

The viability of the bacteria depending on the obtained results was calculated by means of the following formula:

N=(100×C×D×10)/400

wherein:
N refers to the number of viable bacteria observed per cm² of each tested sample,
C refers to the average count of colonies on each gelose plate PCA, and
D refers to the dilution factor used for the counting.

The results of the viability measurements of the bacteria, expressed in log₁₀(N), are gathered in Table 1, the detection limit having been set to a number of recovered bacteria equal to 10 (i.e. log₁₀(N)=1.4).

TABLE 1
Viability of bacteria (log₁₀(N)) according to the silicone film type

| | Escherichia | Staphylococ | Enterococcus | Klebsiella | Acinetobacter | Enterobacter |
|---|---|---|---|---|---|---|
| | coli | cus aureus | faecalis | pneumoniae | baumannii | cloacae |
| Control | 4.4 | 4.2 | 4.3 | 4.0 | 4.6 | 4.4 |
| (without | | | | | | |
| incubation) | | | | | | |
| Control | 6.6 | 4.7 | 4.9 | 6.3 | 6.4 | 7.9 |
| (incubation | | | | | | |
| 24 h) | | | | | | |
| PHGM-DBS | 2.7 | 1.4 | 3.5 | 5.8 | 1.4 | 1.4 |
| (2%) | | | | | | |
| PHGM-DBS | 1.9 | 1.4 | 1.4 | 2.2 | 1.4 | 1.4 |
| (5%) | | | | | | |
| OMIM-BF₄ | 1.4 | 1.6 | 3.6 | 3.3 | 5.8 | 3.6 |
| (2%) | | | | | | |
| OMIM-BF₄ | 1.4 | 1.4 | 1.4 | 4.6 | 1.4 | 1.4 |
| (5%) | | | | | | |
| DMIM-BF₄ | 1.4 | 1.4 | 1.4 | 1.4 | 1.6 | 1.4 |
| (2%) | | | | | | |
| DMIM-BF₄ | 1.4 | 1.4 | 1.4 | 1.4 | 1.4 | 1.4 |
| (5%) | | | | | | |

Insofar that the results are expressed in log₁₀, each difference unit in the measurements of log₁₀(N) means that the number of viable bacteria between both samples differs by a factor 10.

The silicone films of the invention are resistant against the tested bacteria, unlike the control silicone film not comprising any antimicrobial agent. A dose of 2% of antimicrobial agent is sufficient for most of the tested bacteria.

### Example 5B

### Tests on Yeast According to the ISO 22196 Standard

The antibacterial activity of the silicone compositions of the invention was tested on the yeast line Candida albicans IHEM 14796, according to the procedure of the ISO 22196 standard (second edition, 2011).

The silicone films prepared in Example 5A were used.

The procedure followed is identical with that of Example 5A.

The results of the measurements are gathered in Table 2.

TABLE 2
Viability of yeasts (log₁₀(N)) depending on the silicone film type

| | Candida albicans |
|---|---|
| Control (without incubation) | 4.0 |
| Control (incubation 24 h) | 6.2 |
| PHGM-DBS (2%) | 2.8 |
| PHGM-DBS (5%) | 1.4 |
| OMIM-BF₄ (2%) | 6.1 |
| OMIM-BF₄ (5%) | 3.0 |
| DMIM-BF₄ (2%) | 1.4 |
| DMIM-BF₄ (5%) | 1.4 |

The silicone films of the invention are resistant against the tested yeast, unlike the control silicone film not comprising any antimicrobial agent.

### Example 5C

### Tests on a Fungus According to the ISO 16869 Standard

The antifungal activity of the silicone compositions of the invention was tested on the fungus line Penicillium chrysogenum HEM 20859, according to the procedure of the ISO 16869 standard (second edition, 2008).

The silicone films prepared in Example 5A were used.

The procedure of the standard was slightly modified in order to make the results more significant. Thus, each silicone film sample was placed in a Petri dish between a lower layer of nutrient salt agar (20 ml) and an upper layer of Peptone Dextrose agar in which fungus spores were dispersed. The remainder of the procedure of the aforementioned standard was followed.

The culture media were incubated at 25° C. for at least 48 h, and for up to 7 days.

The results are evaluated with the naked eye:
mark 0 is ascribed when no growth is observed,
mark 1 is ascribed when beginning of growth is observed, and
mark 2 is ascribed when obvious growth is observed.

The results of the observations are gathered in Table 3.

TABLE 3
Observation of the growth of fungi
depending on the silicone film type

Penicillium chrysogenum

| | Incubation | Incubation |
|---|---|---|
| | for 48 h | for 7 days |
| Control | 2 | 2 |
| PHGM-DBS (5%) | 0 | 0 |
| DMIM-BF₄ (5%) | 0 | 0 |

The silicone films of the invention are resistant against the tested fungus, unlike the control silicone film not comprising any antimicrobial agent.

### Example 6

### Stability Tests of Antimicrobial Films

The storage of the antimicrobial films F1, F2 and F3 prepared in Example 3 for several months at a temperature of 37° C. does not affect their antimicrobial properties.

The low antimicrobial agent content (5% by mass) gives the possibility of preserving the mechanical properties of the silicone.

The antimicrobial films have heat stability up to at least 350° C. and are resistant to water.

### Example 7

### Test for Measuring the Migration of the Antimicrobial Agents in an Aqueous Medium

The composition of the antimicrobial films F1, F2 and F3 prepared in Example 3 was analyzed by X fluorescence spectroscopy (device AC-1M (manufactured in Ukraine), measurement accuracy of 1 ppm) just after their manufacture.

After staying for six months in water, a new analysis of the films by X fluorescence spectroscopy was carried out.

No variation in the antimicrobial agent concentration in said films was observed.

The antimicrobial films do not salt out or release any antimicrobial agent, even after a prolonged stay in contact with water.

1. A composition, comprising:
at least one non-crosslinked silicone, and
at least one antimicrobial agent dispersed within said silicone, said antimicrobial agent being selected from the group consisting of polymers of ionenes, and of ionic liquids with a molecular mass of less than 1,400 g/mol.

2. The composition according to claim 1, wherein the non-crosslinked silicone is a poly(dimethylsiloxane).

3. The composition according to claim 1, wherein the mass proportion of antimicrobial agent is from 1% to 10% based on the total mass of the composition.

4. The composition according to claim 1, wherein the antimicrobial agent is a poly(polymethylene) guanidine salt, comprising n recurrent units of formula (I-1): 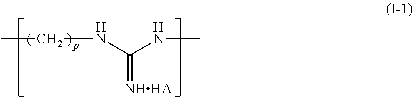
wherein:
p is comprised from 2 to 12,
n is comprised from 4 to 140,
HA is selected from the group consisting of (CF₃SO₂)₂NH, HPF₆ and R—SO₃H,
R is selected from the group consisting of C₄-C₁₂ perfluoroalkyl groups and C₄-C₁₀ aryl groups substituted with at least one group R′, and
R′ is selected from the group consisting of H; C₁-C₁₈ alkyl groups; —NH—CO—R″ groups wherein R″ is a C₁-C₁₇ alkyl group or a C₄-C₁₀ aryl group; and groups —NH—SO₂—C₆H₄—R′″ wherein R′″ is a hydrogen atom or a C₁-C₆ alkyl group.

5. The composition according to claim 4, wherein n=6 and HA represents dodecylbenzenesulfonic acid of formula:

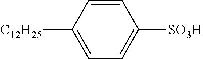

6. The composition according to claim 1, wherein the antimicrobial agent is a salt of poly(polymethylene)imidazolium, comprising n′ recurrent units of formula (I-2): 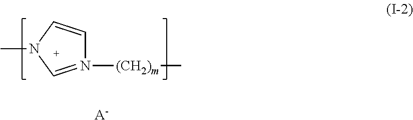
wherein:
m is comprised from 6 to 12,
n′ is comprised from 10 to 100, and
A⁻ is selected from the group consisting of BF₄⁻, PF₆⁻ and (CF₃SO₂)₂N⁻.

7. The composition according to claim 1, wherein the antimicrobial agent is an 1,3-dialkylimidazolium ionic liquid fitting the formula (II-1): 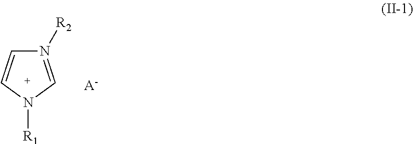
wherein:
A⁻ is selected from the group consisting of BF₄⁻, PF₆⁻ and (CF₃SO₂)₂N⁻,
R₁ is a C₁-C₁₆ alkyl group or a C₅-C₁₆ alkylaryl group, and
R₂ is selected from the group consisting of C₄-C₁₆ alkyl groups, C₅-C₁₆ alkylaryl groups and groups of formula (II-1′): 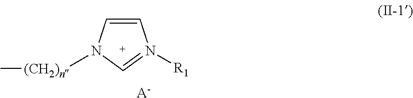
wherein n″ is comprised from 6 to 12, R₁ and A⁻ are as defined above.

8. The composition according to claim 7, wherein the antimicrobial agent is 1-octyl-3-methylimidazolinium tetrafluoroborate or 1-dodecyl-3-methylimidazolinium tetrafluoroborate.

9. The composition according to claim 1, wherein the antimicrobial agent is a guanidinium ionic liquid fitting the formula (II-2): 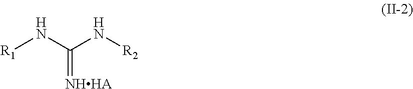
wherein:
R₁ represents a hydrogen atom or a C₁₂-C₁₆ alkyl group,
R₂ represents a C₄-C₁₆ alkyl group,
HA is selected from the group consisting of (CF₃SO₂)₂NH, HPF₆ and R—SO₃H,
R is selected from the group consisting of C₄-₁₂ perfluoroalkyl groups and C₄-C₁₀ aryl groups substituted with a group R′, and
R′ is selected from the group consisting of H; C₁-C₁₈ alkyl groups; —NH—CO—R″ groups wherein R″ is a C₁-C₁₇ alkyl group or a C₄-C₁₀ aryl group; and groups —NH—SO₂—C₆H₄—R′″ wherein R′″ is a hydrogen atom or a C₁-C₆ alkyl group.

10. The composition according to claim 1, wherein the antimicrobial agent is a phosphonium ionic liquid fitting the formula (II-3): 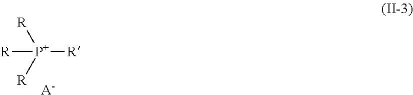
wherein:
R is a C₄-C₁₂ alkyl group,
R′ is selected from the group consisting of C₂-C₁₆ alkyl groups, C₅-C₁₆ alkylaryl groups, and groups of formula (II-3′): 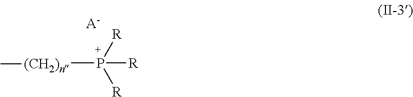
wherein n′″ is comprised from 6 to 12, R being as defined above, and
A⁻ is selected from the group consisting of BF₄⁻, (CF₃SO₂)₂N⁻, PF₆⁻, P(O)(OR₁)₂O⁻ and R₂—SO₃⁻,
R₁ is an alkyl group C₄-C₈,
R₂ is selected from the group consisting of C₄-C₁₂ perfluoroalkyl groups, C₈-C₁₈ alkyl groups, and C₄-C₁₀ aryl groups substituted with a group R₃, and
R₃ is selected from the group consisting of H; C₁-C₁₈ alkyl groups; —NH—CO—R₄ groups wherein R₄ is a C₁-C₁₇ alkyl group or a C₄-C₁₀ aryl group; and groups —NH—SO₂—C₆H₄—R₅ wherein R₅ is a hydrogen atom or a C₁-C₆ alkyl group.

11. An antimicrobial article, comprising:
at least one crosslinked silicone, and
at least one antimicrobial agent dispersed within said crosslinked silicone, said antimicrobial agent being as defined in claim 1.

12. The antimicrobial article according to claim 11, having a desalting rate of the antimicrobial agent of less than 5% per year.
